(19) United States
(12) Patent Application Publication
(10) Pub. No.: US 2017/0249586 A1
(43) Pub. Date: Aug. 31, 2017

(54) SYSTEMS AND METHODS FOR MANAGING PRODUCT PLACEMENT ON DISPLAYS AT RETAIL SALES FACILITIES

(71) Applicant: Wal-Mart Stores, Inc., Bentonville, AR (US)

(72) Inventors: Nicholaus A. Jones, Fayetteville, AR (US); Robert J Taylor, Rogers, AR (US); Matthew A. Jones, Bentonville, AR (US)

(21) Appl. No.: 15/437,712

(22) Filed: Feb. 21, 2017

Related U.S. Application Data
(60) Provisional application No. 62/299,991, filed on Feb. 25, 2016.

(51) Int. Cl. G06Q 10/08; G06K 15/02

(52) U.S. Cl. CPC G06Q 10/087; G06K 15/024

(57) ABSTRACT

In some embodiments, methods and systems of managing product placement at a retail sales facility include an electronic inventory management device configured to obtain electronic data indicating a non-alphanumeric graphical pattern on a product and indicating a location of the non-alphanumeric graphical pattern on the product, and to generate second electronic data corresponding to a shelf label associated with the product. An electronic printing device configured to print the shelf label associated with the product based on the second electronic data is also provided. The printed shelf label associated with the product includes a non-alphanumeric graphical pattern corresponding to the non-alphanumeric graphical pattern on the product. The non-alphanumeric graphical pattern on the product is configured to be aligned with the non-alphanumeric graphical pattern on the printed shelf label when the product and printed label are placed at an intended location onto a shelf on a sales floor of the retail facility.

### RELATED APPLICATIONS

This application claims the benefit of U.S. Provisional Application No. 62/299,991, filed Feb. 25, 2016, which is incorporated herein by reference in its entirety.

### TECHNICAL FIELD

This disclosure relate generally to consumer product labels and more particularly to devices, systems and methods for providing labels facilitating proper placement of the products on product displays at retail sales facilities.

### BACKGROUND

Retail sales facilities such as large department stores typically stock thousands of consumer products on their sales floor shelves and other product displays. Products typically have a label thereon indicating the product name and product information, while a corresponding product display typically has a label indicating the name and price of the product. The label on the product and the label on the product display do not provide any guidance as to exactly where to place the product and how to orient the product when setting the product on the product display.

A disadvantage of such systems is that products are typically set on their product display shelves (or other product display locations) at a retail sales facility by workers such as stocking associates based on the workers' judgment as to where to position the product near the corresponding label on the product display shelf, and how to orient the product on the product display shelf. As a result, the products are sometimes placed in incorrect locations on the product display shelves by workers, or are inadvertently shifted by the workers and/or consumers from their intended locations on the product display shelves to adjacent, but incorrect locations associated with labels for different products. This often results in difficulty for consumers in finding such misplaced/shifted products on the shelves, often leading to false out-of-stock alerts.

### BRIEF DESCRIPTION OF THE DRAWINGS

Disclosed herein are embodiments of systems, apparatuses and methods pertaining to systems and methods of managing product placement at a retail sales facility. This description includes drawings, wherein:

FIG. 1 is a diagram of a system of managing product placement at a retail sales facility in accordance with some embodiments.

FIG. 2 is a simplified block diagram of an electronic inventory management device in accordance with some embodiments;

FIG. 3 shows a simplified block diagram of an exemplary user interface device, in accordance with some embodiments;

FIG. 4 illustrates a simplified view of an exemplary product display location supporting products having labels in accordance with some embodiments;

FIG. 5 illustrates a simplified view of another exemplary product display location supporting products having labels in accordance with some embodiments;

FIG. 6 is a flow diagram of a process of managing product placement at a retail sales facility, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common, well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems, devices and methods are provided that utilize simple and easily recognizable symbols or sets of symbols (e.g., non-alphanumeric graphical patterns) that, when present on products by being marked directly on products or printed on labels attached to the products, facilitate proper placement of the products bearing such symbols on product display locations at retail sales facilities. Such sets of symbols can be printed on a product and on a label attached to the product display location such that the symbols are readily visible to a worker when setting the product on the product display location. As such, when a product bearing such a set of symbols is being set by a worker at a retail sales facility on a product display location having a corresponding set of symbols, the set of symbols on the product label and on the product display location label can be used by a worker to correctly place the product on the product display location by aligning the set of symbols on the product with the set of symbols on the product display location label.

In one embodiment, a system for managing product placement at a retail sales facility includes an electronic inventory management device including a processor-based control unit. The control unit is configured to obtain first electronic data indicating a non-alphanumeric graphical pattern on a first product and indicating a location of the non-alphanumeric graphical pattern on the first product and to generate, based at least on the first electronic data, second electronic data corresponding to a first shelf label associated with the first product. The first printed shelf label associated with the first product includes a non-alphanumeric graphical pattern corresponding to the non-alphanumeric graphical pattern on the first product. The non-alphanumeric graphical pattern on the first product is configured to be aligned with the non-alphanumeric graphical pattern on the first printed shelf label when the first product and the first printed label are placed at an intended location onto a shelf on a sales floor of the retail facility.

In yet another embodiment, a method of managing product placement at a retail sales facility includes: obtaining, at an electronic inventory management device including a processor-based control unit, first electronic data indicating a non-alphanumeric graphical pattern on a first product and indicating a location of the non-alphanumeric graphical pattern on the first product; generating, at the electronic inventory management device and based at least on the first electronic data, second electronic data corresponding to a first shelf label associated with the first product; printing the first shelf label associated with the first product based on the second electronic data, the first printed shelf label associated with the first product including a non-alphanumeric graphical pattern corresponding to the non-alphanumeric graphical pattern on the first product; and placing the first product and the first printed shelf label at an intended location onto a shelf on a sales floor of the retail facility to align the non-alphanumeric graphical pattern on the first product with the non-alphanumeric graphical pattern on the first printed label.

In yet another embodiment, a system of managing product placement at a retail sales facility includes: means for obtaining first electronic data indicating a non-alphanumeric graphical pattern on a first product and indicating a location of the non-alphanumeric graphical pattern on the first product; means for generating, based on the first electronic data, second electronic data corresponding to a first shelf label associated with the first product; means for printing the first shelf label associated with the first product based on the second electronic data, the first printed shelf label associated with the first product including a non-alphanumeric graphical pattern corresponding to the non-alphanumeric graphical pattern on the first product; and means for placing the first product and the first printed shelf label at an intended location onto a shelf on a sales floor of the retail facility to align the non-alphanumeric graphical pattern on the first product with the non-alphanumeric graphical pattern on the first printed label.

FIG. 1 shows an embodiment of a system 100 for facilitating placement of products on product display locations at a retail sales facility 110. The system 100 may be utilized in a single retail sales facility 110 (e.g., brick-and-mortar location where consumer products are sold and/or stocked), or may extend across multiple retail sales facilities 110. It will be appreciated that the system 100 may be utilized not only for facilitating placement of products on product display locations such as shelves or feature displays on the sales floor of the retail sales facility 110, but also for facilitating placement of products in product storage locations such as shelves in a stock room. In addition, it will be appreciated that the terms “product” and “products” refers not only to the individual items sold to consumers, but to packaging (boxes, cases, or the like) that is used to retain the products while being displayed to consumers on a shelf on the sales floor.

The exemplary system 100 of FIG. 1 includes an electronic inventory management device 120. The electronic inventory management device 120 facilitates management of the inventory of products and the labeling of product display locations at the retail sales facility 110 based on the labels present on products at the retail sales facility 110.

The electronic inventory management device 120 of FIG. 1 may be a stationary or portable electronic device, for example, a desktop computer, a laptop computer, a tablet, a mobile phone, or any other electronic device including a processor-based control circuit (i.e., control unit). The electronic inventory management device 120 may include and/or couple to one or more wired and/or wireless distributed communication network 115 (e.g., wide area network (WAN), local area network (LAN), wireless local area network (WLAN), Internet, cellular, other such networks, and combinations of such networks). The electronic inventory management device 120 is configured for data entry and one-way and/or two-way communication via the communication network 115 with, for example, an inventory management database 130, a user interface device 140, a print unit 150, remote server 160, and/or any other computing device (e.g., regional and/or central server) located at the retail sales facility 110 or remote to the retail sales facility 110.

In the embodiment shown in FIG. 1, the system 100 includes an inventory management database 130 configured to store electronic information associated with the products at the retail sales facility, as well as labels associated with the products at the retail sales facility 110, and labels associated with product display locations at the retail sales facility 110. The inventory management database 130 may store electronic data including: identification data associated with the products stored at the retail sales facility 110, product label data indicating a set of symbols indicated on a given product and/or indicating a location of the set of symbols on the given product 190, and product display location label data indicating a set of symbols to be printed on a label for placement on a product display location.

While the inventory management database 130 is shown in FIG. 1 as being separate from the electronic inventory management device 120 and in communication with the electronic inventory management device 120 via the communication network 115, it will be appreciated that the inventory management database 130 may be physically incorporated into and/or be electrically coupled (e.g., via a cable) to the electronic inventory management device 120. In addition, while one inventory management database 130 is shown in FIG. 1, the inventory management database 130 may include two or more separate databases, for example, one or more product inventory database and one or more symbol database that are in communication with each other.

The inventory management database 130 may be stored, for example, on non-volatile storage media (e.g., a hard drive, flash drive, or removable optical disk) internal to or external to relative to the electronic inventory management device 120. The inventory management database 130 may be stored on one or more servers or may be cloud-based. In some embodiments, the electronic data stored in the inventory management database 130 may be received from the electronic inventory management device 120. In some embodiments, the electronic data stored in the inventory management database 130 may be transmitted to the inventory management database 130 from another device, for example, remote server 160.

In the embodiment shown in FIG. 1, the system 100 includes one or more remote servers 160 configured to store and transmit symbol data associated with each of the products 190 delivered to the retail sales facility 110. In some embodiments, the remote server 160 may be in the form of a plurality of servers operated by vendors that manufacture the products delivered to the retail sales facility 110. In such embodiments, the remote servers 160 store electronic product label data indicating a set of symbols on a vendor's product and indicating a location of the set of symbols on the product, and transmit such label data via the network 115 to the electronic inventory management device 120 and/or the inventory management database 130.

In some embodiments, the set of symbols on the vendors' products is in the form of one or more non-alphanumeric graphical patterns depicted on one or more sides of the product (e.g., front panel, rear panel, and/or side panel). The set of symbols may appear near the top or bottom and near the middle or near a corner of one of more sides of the product such that when the product is placed on a product display location (e.g., a shelf) having a label including a matching set of non-alphanumeric symbols, the proximity of the two sets makes it easy for the worker at the retail sales facility 110 to see the complementary nature of the two sets of symbols. In some embodiments, the set of symbols on the vendors' products may be in the form of a single line, two lines, three lines, or four or more lines. In some embodiments, the set of symbols on the vendors' products may be in the form of one or more geometric figures such as circles, triangles, squares, stars, or the like. In some embodiments, the set of symbols on the vendors' products may be in the form of one or more irregular shapes.

In other embodiments, the remote server 160 is in the form of one or more regional servers associated with the retail sales facility 110 and in communication with a plurality of servers operated by vendors that manufacture the products delivered to the retail sales facility 110. In such embodiments, the remote server 160 is configured to receive product label data (e.g., electronic data indicating a set of symbols on a product and indicating a location of the set of symbols on the product from the vendor-operated servers), to store the product label data received from the vendor servers, and to transmit the product label data via the network 115 to the electronic inventory management device 120 and/or the inventory management database 130.

The exemplary system 100 also includes a print unit 150 in communication with the electronic inventory management device 120 via the network 115 or via an electrical connection such as a cable. The print unit 150 is configured to receive electronic data generated by the control unit 210 of the electronic inventory management device 120 and to print a shelf label associated with the product based on such received electronic data. In some embodiments, one or more sets of product placement symbols including graphical patterns for one or more shelf labels to be aligned with one or more complementary graphical patterns on one or more products can be communicated by the electronic inventory management device 120 to the print unit 150 to be printed onto a shelf label that may be affixed to a product display location (e.g., a shelf). Workers at the retail sales facility 110 can utilize the printed shelf labels including the printed sets of symbols on the shelf labels for properly aligning the product placement labels on the products with the shelf labels on the product display locations such as shelves and/or other product display support structures at the retail sales facility 110.

In some embodiments, the print unit 150 is a stationary printer, while in other embodiments, the system 100 may include portable user interface devices 140 in communication with the electronic inventory management device 120 via the network 115 and configured to print one or more shelf labels including the aforementioned product placement-facilitating symbols. As such, a worker at the retail sales facility 110 operating a user interface device 140 (e.g., an electronic hand-held scanner or a mobile tablet having a print unit) can receive an instruction from the electronic inventory management device 120 to print and apply a shelf label onto a product display location where products having matching product placement symbols are to be displayed.

In the embodiment of FIG. 1, product vendors (e.g., manufacturers) affix and/or print one or more sets of product placement symbols on the products and/or on the product packaging. In some embodiments, products are received at the retail sales facility 110 without including such sets of product placement symbols, and the electronic inventory management device 120 may be configured to cause the print unit 150 to print one or more product placement labels including appropriate sets of product placement symbols for each of such products. Based on the product placement labels generated for such products, the electronic inventory management device 120 can cause the print unit 150 to print one or more shelf labels having sets of symbols complementary to the product placement symbols on the labels printed for the products. As such, even products that are received at the retail sales facility 110 without product placement symbols and/or labels may be provided with product placement labels at the retail sales facility 110 and placed in alignment with shelf labels on product display locations at the retail sales facility 110.

In some embodiments, the electronic inventory management device 120 is in communication via the network 115 with one or more user interface device 140. The user interface device 140 can be any electronic device configured for wired and/or wireless communication with the electronic inventory management device 120. The user interface devices 140 allow a user (e.g., a worker at the retail sales facility 110) to communicate with the electronic inventory management device 120 to receive and/or transmit information and communication relevant to generation of shelf labels for product display locations at the retail sales facility 110, as well as to communicate with the inventory management database 130 and/or the print unit 150. For example, the user interface device 140 may include but is not limited to a smart phone, cell phone, tablet, laptop, retail sales facility-specific wireless communication devices (e.g., electronic hand-held product scanners), or the like.

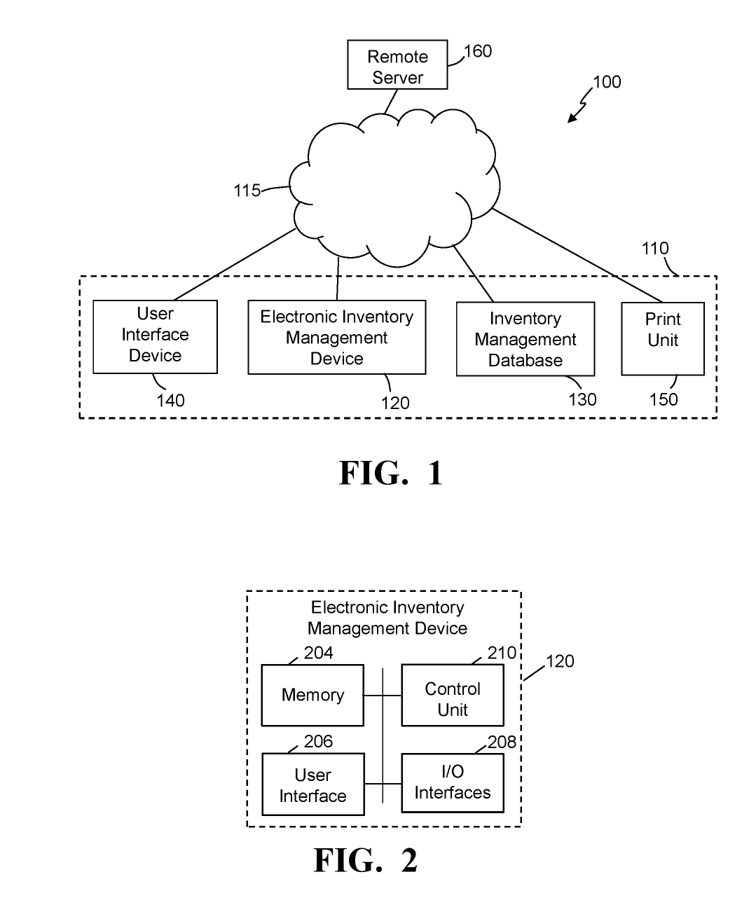

FIG. 2 shows a simplified block diagram of an exemplary electronic inventory management device 120, in accordance with some embodiments. The electronic inventory management device 120 includes one or more processor-based control circuits or control unit 210, memory 204, and input/output (I/O) interfaces 208. The electronic inventory management device 120 also includes one or more user interfaces 206 that allows users to interact with the inventory management database 130, user interface device 140, the print unit 150, and/or remote server 160.

In some embodiments, the control unit 210 includes one or more processors and/or microprocessors. The control unit 210 couples with and/or includes the memory 204. Generally, the memory 204 stores the operational code or set of instructions that is executed by the control unit 210 and/or processor to implement the functionality of the electronic inventory management device 120. It is understood that the control unit 210 may be implemented as one or more processor devices as are well known in the art. Similarly, the memory 204 may be implemented as one or more memory devices as are well known in the art, such as one or more processor readable and/or computer readable media and can include volatile and/or nonvolatile media, such as RAM, ROM, EEPROM, flash memory and/or other memory technology. In some embodiments, the control unit 210 comprises a fixed-purpose hard-wired platform or can comprise a partially or wholly programmable platform. These architectural options are well known and understood in the art and require no further description here. The control unit 210 can be configured (for example, by using corresponding programming as will be well understood by those skilled in the art) to carry out one or more of the steps, actions, and/or functions described herein.

While the memory 204 is shown as internal to the electronic inventory management device 120, the memory 204 can be internal, external or a combination of internal and external memory. Also, the electronic inventory management device 120 may include a power supply (not shown) or it may receive power from an external source. In some instances, the control unit 210 and the memory 204 may be integrated together, such as in a microcontroller, application specification integrated circuit, field programmable gate array or other such device, or may be separate devices coupled together.

The one or more I/O interfaces 208 allow wired and/or wireless communication coupling of the electronic inventory management device 120 to external components, such as the inventory management database 130, user interface device 140, print unit 150, remote server 160, and other such components. Accordingly, the I/O interfaces 208 may include any known wired and/or wireless interfacing device, circuit and/or connecting device. For example, in some implementations, the I/O interface 208 includes one or more transceivers, receivers, and/or transmitters that provide wireless communication in accordance with one or more wireless protocols (e.g., Wi-Fi, Bluetooth, radio frequency (RF), cellular, other such wireless communication, or combinations of such communication).

The user interface 206 of the electronic inventory management device 120 can include substantially any known input device, such one or more buttons, knobs, selectors, switches, keys, touch input surfaces and/or displays, etc. Additionally, the user interface 206 may include one or more output display devices, such as lights, visual indicators, display screens, etc. to convey to a user any information relating to product placement at the retail sales facility 110. While FIG. 2 illustrates the exemplary components of the electronic inventory management device 120 being coupled together via a bus, it is understood that the components may actually be coupled to the control circuit 210 and/or one or more other components directly.

In some embodiments, the control unit 210 of the electronic inventory management device 120 is configured to generate, for a product, based at least on a first set of electronic data including a set of symbols obtained from the inventory management database 130, a second set of electronic data corresponding to a first shelf label for the product and including set of symbols matching the set of symbols of the first set of electronic data. In some embodiments, both the first set of symbols obtained from the inventory management database 130 and the second of symbols generated by the control unit 210 for printing on the first shelf label are non-alphanumeric graphical patterns such as one or more lines or other geometric or irregular shapes. The term non-alphanumeric will be understood to refer to symbols that do not include letters, numbers or other characters that are typically associated with written language.

In some embodiments, the control unit 210 of the electronic inventory management device 120 may be programmed in some embodiments to query the inventory management database 130 to determine whether the non-alphanumeric graphical pattern depicted on a first product matches the non-alphanumeric graphical pattern of another product to be displayed on a nearby product display location. If the non-alphanumeric graphical pattern depicted on the first product is determined based on the inventory management database 130 query to match a non-alphanumeric graphical pattern of another product to be displayed near the first product, the control unit 210 is programmed in some embodiments to cause the electronic inventory management device 120 to transmit a signal via the network 115 to the remote server 160. The remote server 160, which is accessible by the vendor who manufactured the product that was determined to have a duplicative non-alphanumeric graphical pattern, can modify the alphanumeric graphical pattern on the subsequent units of this product delivered to the retail sales facility 110. This advantageously reduces situations where two products stored at product display locations in proximity to each other another have the same graphical patterns printed on their labels.

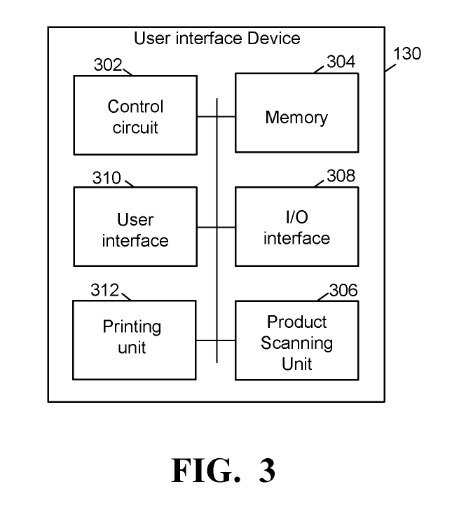

FIG. 3 shows a simplified block diagram of an exemplary user interface device 130, in accordance with some embodiments. The user interface device 130 includes one or more control circuits 302, memory 304, input/output (I/O) interfaces 308, and user interfaces 310. In some implementations, the user interface device 130 may include a product scanning unit 306 (e.g., barcode reader, radio frequency identification (RFID) reader, optical reader, or the like), and a printing unit 312.

In some embodiments, the control circuit 302 includes one or more processors and/or microprocessors. The memory 304 stores the operational code or set of instructions that is executed by the control circuit 302 and/or processor to implement the functionality of the user interface unit 130. In some embodiments, the memory 304 may also store some or all of particular data that may be needed to make any of the associations, determinations, measurements and/or communications described herein. Such data may be pre-stored in the memory, received from an external source (e.g., the electronic inventory management device 120), be determined, and/or communicated to the user interface unit.

The control circuit 302 and/or processor may be implemented as one or more processor devices as are well known in the art. Similarly, the memory 304 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 304 is shown as internal to the user interface device 130, but the memory 304 can be internal, external or a combination of internal and external memory. Additionally, the user interface device 130 may include a power supply (not shown) that may be rechargeable and/or it may receive power from an external source. While FIG. 3 illustrates the components of the user interface device 140 being coupled together via a bus, it is understood that the components of the user interface device 140 may be coupled to the control circuit 302 and/or one or more other components directly.

Generally, the control circuit 302 and/or electronic components of the user interface device 130 can include fixed-purpose hard-wired platforms or can comprise a partially or wholly programmable platform. These architectural options are well known and understood in the art and require no further description here. The user interface unit and/or control circuit can be configured (for example, by using corresponding programming as will be well understood by those skilled in the art) to carry out one or more of the steps, actions, and/or functions described herein. In some implementations, the control circuit 302 and the memory 304 may be integrated together, such as in a microcontroller, application specification integrated circuit, field programmable gate array or other such device, or may be separate devices coupled together.

The I/O interface 308 allows wired and/or wireless communication coupling of the user interface device 140 to external components, such as the electronic inventory management device 120, inventory management database 130, print unit 150, and/or remote server 160 shown in FIG. 1. Typically, the I/O interface 308 provides at least wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitter, receiver, transceiver, etc.

The user interface 310 may be used for user input and/or output display. For example, the user interface 310 may include any known input devices, such one or more buttons, knobs, selectors, switches, keys, touch input surfaces, audio input, and/or displays, etc. Additionally, the user interface 310 may include one or more output display devices, such as lights, visual indicators, display screens, etc. to convey information relevant to product placement labels and/or shelf labels to a user such as a worker at the retail sales facility 110. The user interface 310 in some embodiments may also include audio systems that can receive audio commands or requests verbally issued by a user, and/or output audio content.

In some embodiments, the user interface device 140 includes a product scanning unit 306 configured to scan identifying indicia located on the products or on the packaging containing the products. The identifying indicia on the products that may be scanned by the product scanning unit 306 may include, but is not limited to: two dimensional barcode, RFID, near field communication (NFC) identifiers, ultra-wideband (UWB) identifiers, Bluetooth identifiers, images, or other such optically readable, radio frequency detectable or other such code, or combination of such codes.

The user interface device 140 according to some embodiments may include a printing unit 312. The printing unit 312 can be configured to allow the user interface device 140 to print one or more labels, images, sets of symbols or the like that may be placed on the product display location (e.g., on a shelf on the sales floor of the retail sales facility 110). As such, a worker at a retail sales facility 110 may be instructed by an on-screen message on the user interface device 140, instructing the worker to print, using the printing unit of the user interface device 140, a shelf label having a set of symbols corresponding to a set of symbols present on a given product received from a vendor, and to apply the printed shelf label onto a product display location associated with the given product, or to print a product placement label including a unique set of symbols generated by the control unit 210 of the electronic inventory management device 120, and to affix the printed product placement label onto the given product.

As described above and further below, each product at the shopping facility can include one or more non-alphanumeric symbols that may be unique to the product in terms of the number and/or orientation of the symbols and in terms of the location of the symbols on the product. In some embodiments, a set of one or more symbols (i.e., product placement symbols) are printed, affixed or otherwise temporarily placed on a product and/or shipping packaging (e.g., box, wrapping, other such packaging) delivered to the retail sales facility 110. The set of symbols may be printed or affixed on multiple, if not all, of the sides of the product and/or product packaging. The set of symbols is readily visible to a worker when handling the product and can be visually distinguished from other sets of symbols on other products and/or other shelf labels affixed to product display locations. As such, the workers at a retail sales facility can visually distinguish a particular product from other products based on the unique set or sets of non-alphanumeric symbols present on such products.

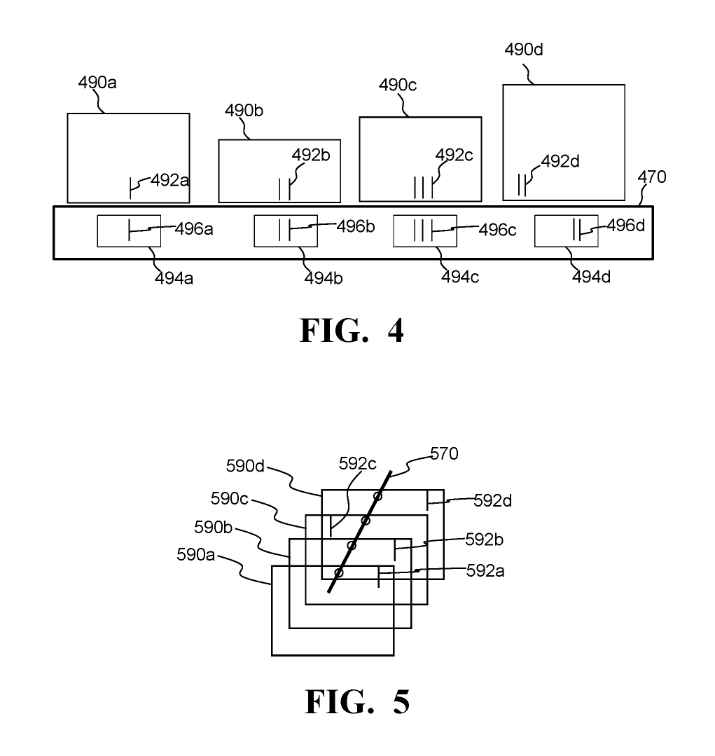

FIG. 4 illustrates a simplified view of an exemplary product display location 470, which may be a shelf as shown in FIG. 4, a hanging rack 474 as shown in FIG. 5, or other such structures that may support and/or hold one or more products 490a-d and 590a-590d or shipping packaging of the products 490a-d and 590a-590d at the retail sales facility 110. In the embodiment shown in FIG. 4, each of products 490a-d is different as illustrated by the different sizes of the products 490a-d, and as indicated by each product 490a-d having a unique set of graphical patterns or non-alphanumeric symbols 492a-492d.

In FIG. 4, the product 490a includes a set of symbols 492a in the form of a single vertical line positioned at the middle and proximate the bottom of the front-facing side of the product 490a. The product 490b includes a set of symbols 492b in the form of two spaced and parallel vertical lines positioned at the middle and proximate the bottom of the front-facing side of the product 490b. The product 490c includes a set of symbols 492c in the form of three spaced and parallel vertical lines positioned at the middle and proximate the bottom of the front-facing side of the product 490c. The product 490d includes a set of symbols 492d in the form of two spaced and parallel vertical lines positioned at the corner and proximate the bottom of the front-facing side of the product 490d. The product display location 470 further includes shelf labels 494a-d each including a set of symbols 496a-d as shown in FIG. 4, and which may include additional information (not illustrated for simplification) associated with the products 490a-d, for example the name of each of the products 490a-d and/or the price of each of the products 490a-d and/or identifying indicia (e.g., barcode or the like) that may be scanned by a user interface device 140.

Accordingly, a worker at the retail sales facility 110, when looking at the product display location 470, can readily identify and distinguish the products 490a-d and determine which of the products 490a-d is incorrectly placed on the product display location 470. Specifically, in FIG. 4, product 490d is incorrectly placed on the product display location 470, since the graphical pattern or non-alphanumeric symbols 492d on the product 490d are clearly not aligned with the graphical pattern or non-alphanumeric symbols 496d on the shelf label 494d.

As can be seen in FIG. 4, the sets of symbols 492a-d visually distinguish the products 490a-d from each other and may also visually distinguish the products 490a-d from other products at the retail sales facility 110. As discussed above, the sets of symbols 492a-d are printed on or affixed to the products 490a-d by the vendor (e.g., product manufacturer of the products 490a-d), or may be printed (e.g., via print unit 150 and/or printing unit 312 at the retail sales facility 110). Preferably, the sets of symbols 492a-d are non-alphanumeric (i.e., do not include letters, numbers or other characters that are typically associated with written language), which allows a worker at the retail sales facility 110 to readily identify the products 490a-d regardless of what language the worker reads or understands, or even when the worker cannot read. While the non-alphanumeric symbols 492a-d have been shown as vertical lines in FIG. 4, it will be appreciated that non-vertical (e.g., slanted, horizontal, or zig-zagging) lines, as well as other geometric and/or irregular shapes may be used as the non-alphanumeric symbols 492a-d to facilitate proper placement of the products 490a-490d on the product display location 470.

In the example illustrated in FIG. 5, a product display location 570 such as a hanging rack includes products 590a-d hanging therefrom, with each of the products 590a-d having a graphical pattern or a set of non-alphanumeric symbols 592a-d printed or affixed as a label thereon. The non-alphanumeric sets of symbols 592a-d on the products 590a-d in FIG. 5 each comprise a single vertical line positioned at the upper corner of the front-facing side of the product 590a-d. However, while the non-alphanumeric set of symbols 592a, 592b, and 592d of the products 590a, 590b, and 590d, respectively, are positioned in the upper right corner of each of the products 590a, 590b, and 590d, the non-alphanumeric set of symbols 592c is located in the upper left corner of the product 590c. Accordingly, a worker at the retail sales facility 110, when looking at the product display location 570 can readily determine which of the products 590a-d is incorrectly placed on the product display location 570. Specifically, in FIG. 5, product 590c is incorrectly placed and should not be on the product display location 570, since the graphical pattern or non-alphanumeric symbol 592c on the product 590c is clearly not aligned with the graphical pattern or non-alphanumeric symbols 592a, 592b, and 592d on the products 590a, 590b, and 590d, indicating that the product 590c is different from each of products 590a, 590b, and 590d.

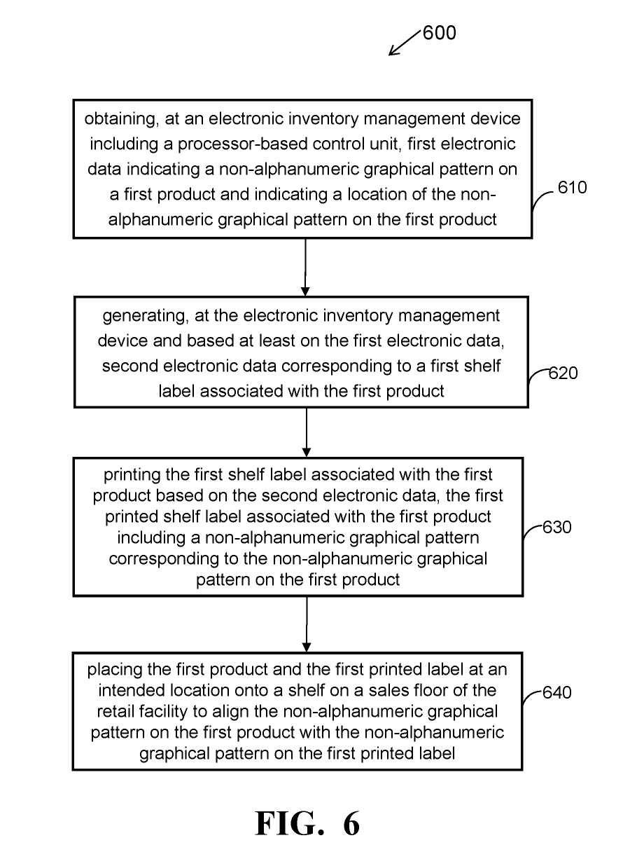

FIG. 6 illustrates a simplified flow diagram of an exemplary process 600 of managing placement of products on product display locations at a retail sales facility 110. While the process 600 will be discussed as it applies to the products 490a-490d of FIG. 4, it will be appreciated that the process 600 may be utilized in connection with any of the embodiments described herein. In step 610, first electronic data indicating a non-alphanumeric graphical pattern (e.g., 492a) on a first product (e.g., 490a) and indicating a location of the non-alphanumeric graphical pattern on the first product is obtained at an electronic inventory management device 120 including a processor-based control unit 210. As discussed above, this first electronic data indicating the non-alphanumeric graphical pattern on the product may be transmitted from the remote server 160 (e.g., a server of a vendor) to the electronic inventory management device 120 and/or to the inventory management database 130.

In step 620, the electronic inventory management device 120 generates, based at least on the obtained first electronic data, second electronic data corresponding to a first shelf label (e.g., 494a) associated with the first product and indicating a non-alphanumeric graphical pattern (e.g., 496a) on the first shelf label. As discussed above, such second electronic data may be generated by the control unit 210 of the electronic inventory management device 120 and transmitted via the network 115 to the print unit 150 or to the user interface device 140 having a printing unit 312 for printing a physical shelf label for attachment to the product display location such as a shelf 470, a hanging rack 570, or another product display and/or storage location at the retail sales facility 110. In some embodiments, the control unit 210 of the electronic inventory management device 120 generates the second electronic data corresponding to the first shelf label based on retrieving, from the inventory management database 130, the first electronic data indicating the non-alphanumeric graphical pattern on the product and the location of the non-alphanumeric graphical pattern on the product.

Step 630 includes the printing of the first shelf label (e.g., 494a) associated with the first product (e.g., 490a) based on the second electronic data generated by the control unit 210 of the electronic inventory management device 120. The first printed shelf label 494a associated with the first product 490a includes a non-alphanumeric graphical pattern (e.g., 496a) corresponding to the non-alphanumeric graphical pattern (e.g., 492a) on the first product 490a. As discussed above, the printing of the first shelf label 494a may be performed in some embodiments by the print unit 150 upon receiving a signal from the electronic inventory management device 120 including the second electronic data (e.g., graphical pattern including non-alphanumeric symbols generated by the control unit 210 for the shelf label 494a based on the known non-alphanumeric symbols 492a of the product 490a).

In other embodiments, the printing of the first shelf label 494a may be performed by the printing unit 312 of the user interface device 140 upon receiving a signal from the electronic inventory management device 120 including the second electronic data (e.g., graphical pattern including non-alphanumeric symbols generated by the control unit 210 for the shelf label 494a based on the known non-alphanumeric symbols 492a of the product 490a). Step 640 includes placing, by a worker at the retail sales facility 110, of the first product 490a and the first printed label 494a at an intended location onto a shelf 470 on a sales floor of the retail facility 110 to align the non-alphanumeric graphical pattern 492a on the first product 490a with the non-alphanumeric graphical pattern 496a on the first printed (i.e., shelf) label 494a.

As described above, in some instances, products received at the retail sales facility 110 do not include a unique set of non-alphanumeric symbols on the products, and a product label including a unique set of non-alphanumeric symbols may be printed on labels and affixed to the products at the retail sales facility 110 as discussed above. In some embodiments, the electronic inventory management device 120 (e.g., through the control unit 210) may be configured to receive a notification (e.g., from the inventory management database 140) indicating whether the products received at the retail sales facility via delivery include or do not include a set of non-alphanumeric symbols that facilitate placement of the products on the product display location at the retail sales facility 110. In such embodiments, in response to receiving a notification that some of the products received at the retail sales facility do not include the product-placement facilitating set of non-alphanumeric symbols, the control unit 210 of the electronic inventory management device 120 can generate such sets of symbols and cause such sets of symbols to be printed on labels configured to be affixed to each of the products lacking such product-placement facilitating symbols, and to then, based on the generated sets of symbols for printing on product labels, to generate electronic data corresponding to product placement-facilitating shelf labels associated with such products.

In some embodiments, a worker at a retail sales facility 110 may be instructed (e.g., via a display or speaker of the user interface device 140) to confirm that the products placed at a certain product display location at the retail sales facility 110 are actually the products intended to be at that product display location. Since the products and their respective shelf labels include clearly visible sets of symbols as shown in FIGS. 4-5, the worker is able to quickly confirm whether one or more products are incorrectly placed at the product display location visually, without having to manual scan each of the products, and to manually enter data into the user interface device 140 (for transmission to the inventory management database 140) to indicate whether any of the products at the product display location are placed in incorrect physical locations, or are products that are not meant for that product display location. As such, the inventory management database 130 may be updated in real time to include information relating to the monitoring of correct/incorrect placement of products at the retail sales facility 110.

In some embodiments, the sets of symbols on the products stored/displayed at the retail sales facility 110 may be selected by the manufacturer of the product and/or by a symbol distributor to which all product manufacturers submit requests/queries relating to product placement symbols. For example, a product manufacturer may submit one or more symbols (e.g., to the remote server 160 or to the electronic inventory management device 120) requesting that the one or more symbols be exclusively associated with a product made by that manufacturer. The remote server 160 or the electronic inventory management device 120 may evaluate the request and authorize the request when there is not another set of symbols corresponding to another product that is the same or similar to the requested set of symbols. Conversely, the remote server 160 or the electronic inventory management device 120 may deny the request after a determination that the inventory management database 130 already includes a set of symbols corresponding to another product that is the same to the requested set of symbols.

The systems and methods described herein provide for labeling of products with unique sets of non-alphanumeric characters and labeling of product display locations with shelf labels including complementary sets of non-alphanumeric characters. Such labels permit workers at retail sales facilities to visually confirm, without having to manually scan the products, whether the products displayed in product display locations at the retail sales facility are in a correct physical position for display, as well as whether the products displayed in the product display locations are correct products for those product display locations. Accordingly, the systems and methods described herein advantageously improve worker efficiency and provide for significant cost savings to the retail sales facilities.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for managing product placement at a retail sales facility, the system comprising:
an electronic inventory management device including a processor-based control unit, the control unit configured to:
obtain first electronic data indicating a non-alphanumeric graphical pattern on a first product and indicating a location of the non-alphanumeric graphical pattern on the first product; and
generate, based at least on the first electronic data, second electronic data corresponding to a first shelf label associated with the first product; and
an electronic printing device in communication with the electronic inventory management device and configured to print the first shelf label associated with the first product based on the second electronic data;
wherein the first printed shelf label associated with the first product includes a non-alphanumeric graphical pattern corresponding to the non-alphanumeric graphical pattern on the first product; and
wherein the non-alphanumeric graphical pattern on the first product is configured to be aligned with the non-alphanumeric graphical pattern on the first printed shelf label when the first product and the first printed label are placed at an intended location onto a shelf on a sales floor of the retail facility.

2. The system of claim 1, further comprising an electronic database stored on a server operated by a manufacturer of the first product, and wherein the electronic inventory management device is configured to receive the first electronic data from the electronic database.

3. The system of claim 1, wherein the location of the non-alphanumeric graphical pattern on the first product comprises a surface of a label affixed on the first product, a surface of the first product, and a surface of a packaging material of the first product.

4. The system of claim 3, wherein the control unit is further configured to obtain third electronic data indicating a non-alphanumeric graphical pattern on a second product and indicating a location of the non-alphanumeric graphical pattern on the second product, the non-alphanumeric graphical pattern on the second product being visually different from the non-alphanumeric graphical pattern on the first product and different from the non-alphanumeric graphical pattern on the first printed label when viewed by a worker at the retail sales facility.

5. The system of claim 4, wherein the control unit is further configured to:
generate, based at least on the third electronic data, fourth electronic data corresponding to a second shelf label associated with the second product; and
wherein the electronic printing device is further configured to print the second shelf label associated with the second product based on the fourth electronic data, the second printed shelf label associated with the second product including a non-alphanumeric graphical pattern corresponding to the non-alphanumeric graphical pattern on the second product and being visually different from the non-alphanumeric graphical pattern on the first product and different from the non-alphanumeric graphical pattern on the first printed label when viewed by a worker at the retail sales facility.

6. The system of claim 2, wherein the electronic inventory management device is configured for communication with an electronic database configured to store the first electronic data, and wherein the control unit is further configured to query the electronic database to determine whether the non-alphanumeric graphical pattern depicted on the first product matches a non-alphanumeric graphical pattern of another product to be stored on the shelf on the sales floor of the retail sales facility, and wherein the control unit is further configured to cause the electronic inventory management device to transmit a signal to the server operated by a manufacturer of the first product, the signal indicating that the non-alphanumeric graphical pattern depicted on the first product matches a non-alphanumeric graphical pattern of another product to be stored on the shelf on the sales floor of the retail sales facility.

7. The system of claim 1, wherein the electronic inventory management device further includes a transmitter configured to transmit the second electronic data to the electronic printing device and wherein the electronic printing device further includes a receiver configured to receive the second electronic data from the electronic inventory management device.

8. The system of claim 7, wherein the electronic inventory management device is configured to transmit the second electronic data via a signal to an electronic product scanning device in communication with the electronic printing device, and wherein the electronic product scanning device is configured to transmit the second electronic data via another signal to the electronic printing device, and wherein the electronic printing device is configured to print the first shelf label based on the signal transmitted from the electronic product scanning device.

9. The system of claim 1, wherein the control unit of the electronic inventory management device is further configured to determine, based at least on the first electronic data, intended location on the shelf on the sales floor of the retail sales facility for the placement of each of the first product and the first printed label such that when the first product and first printed label are placed in their respective intended location, the non-alphanumeric graphical pattern on the first product aligns with the non-alphanumeric graphical pattern on the first printed label.

10. The system of claim 1, wherein the non-alphanumeric graphical pattern includes one or more lines, and wherein the one or more lines on the first product is aligned with the one or more lines on the first printed label when the first product and the first printed label are placed into their respective intended location on the shelf.

11. A method of managing product placement at a retail sales facility, the method comprising:
obtaining, at an electronic inventory management device including a processor-based control unit, first electronic data indicating a non-alphanumeric graphical pattern on a first product and indicating a location of the non-alphanumeric graphical pattern on the first product;
generating, at the electronic inventory management device and based at least on the first electronic data, second electronic data corresponding to a first shelf label associated with the first product;
printing the first shelf label associated with the first product based on the second electronic data, the first printed shelf label associated with the first product including a non-alphanumeric graphical pattern corresponding to the non-alphanumeric graphical pattern on the first product; and
placing the first product and the first printed shelf label at an intended location onto a shelf on a sales floor of the retail facility to align the non-alphanumeric graphical pattern on the first product with the non-alphanumeric graphical pattern on the first printed label.

12. The method of claim 11, wherein the obtaining step further comprises receiving the first electronic data at the electronic inventory management device from an electronic database stored on a server operated by a manufacturer of the first product.

13. The method of claim 11, wherein the location of the non-alphanumeric graphical pattern on the first product comprises a surface of a label affixed on the first product, a surface of the first product, and a surface of a packaging material of the first product.

14. The method of claim 13, wherein the obtaining step further comprises, obtaining, at the electronic inventory management device, third electronic data indicating a non-alphanumeric graphical pattern on a second product and indicating a location of the non-alphanumeric graphical pattern on the second product, the non-alphanumeric graphical pattern on the second product being visually different from the non-alphanumeric graphical pattern on the first product and different from the non-alphanumeric graphical pattern on the first printed label when viewed by a worker at the retail sales facility.

15. The method of claim 14, further comprising:
generating, at the electronic inventory management device and based on the control unit processing the third electronic data, fourth electronic data corresponding to a second shelf label associated with the second product; and
printing the second shelf label associated with the second product based on the fourth electronic data, the second printed shelf label associated with the second product including a non-alphanumeric graphical pattern corresponding to the non-alphanumeric graphical pattern on the second product and being visually different from the non-alphanumeric graphical pattern on the first product and different from the non-alphanumeric graphical pattern on the first printed label when viewed by a worker at the retail sales facility.

16. The method of claim 12, wherein the obtaining step further comprises storing the first electronic data on an electronic database in communication with the electronic inventory management device and further comprising querying the electronic database, via the control unit of the electronic inventory management device, to determine whether the non-alphanumeric graphical pattern depicted on the first product matches a non-alphanumeric graphical pattern of another product to be stored on the shelf on the sales floor of the retail sales facility, and further comprising transmitting a signal from the electronic inventory management device to the server operated by a manufacturer of the first product, the signal indicating that the non-alphanumeric graphical pattern depicted on the first product matches a non-alphanumeric graphical pattern of another product to be stored on the shelf on the sales floor of the retail sales facility.

17. The method of claim 11, wherein the printing step further comprises transmitting the second electronic data via a signal from the electronic inventory management device to an electronic printing device configured for printing the first shelf label associated with the first product based on the second electronic data and printing the first shelf label from the electronic printing device.

18. The method of claim 17, wherein the transmitting step further comprises transmitting the second electronic data via a signal from the electronic inventory management device to a product scanning device in communication with the electronic printing device, transmitting the second electronic data via another signal from the electronic product scanning device to the electronic printing device, and printing the first shelf label from the electronic printing device.

19. The method of claim 11, wherein the generating step further comprises, determining, via the control unit of the electronic inventory management device and based on the control unit processing the first electronic data, the intended location on the shelf on the sales floor of the retail sales facility for the placement of each of the first product and the first printed label such that when the first product and first printed label are placed in their respective intended location, the non-alphanumeric graphical pattern on the first product aligns with the non-alphanumeric graphical pattern on the first printed label.

20. The method of claim 11, wherein the non-alphanumeric graphical pattern includes one or more lines, and wherein the placing step further comprises placing the first product and the first printed label into their respective intended location on the shelf to align the one or more lines on the first product with the one or more lines on the first printed label.

21. A system of managing product placement at a retail sales facility, the system comprising:
means for obtaining first electronic data indicating a non-alphanumeric graphical pattern on a first product and indicating a location of the non-alphanumeric graphical pattern on the first product;
means for generating, based on the first electronic data, second electronic data corresponding to a first shelf label associated with the first product;
means for printing the first shelf label associated with the first product based on the second electronic data, the first printed shelf label associated with the first product including a non-alphanumeric graphical pattern corresponding to the non-alphanumeric graphical pattern on the first product; and
means for placing the first product and the first printed shelf label at an intended location onto a shelf on a sales floor of the retail facility to align the non-alphanumeric graphical pattern on the first product with the non-alphanumeric graphical pattern on the first printed label.
